(19) United States
(12) Patent Application Publication
(10) Pub. No.: US 2014/0082728 A1
(43) Pub. Date: Mar. 20, 2014

(54) DONGLE DEVICE FOR WIRELESS INTRUSION PREVENTION

(71) Applicant: Electronics and Telecommunications Research Institute, Daejeon (KR)

(72) Inventors: Sin Hyo KIM, Daejeon (KR); Sok Joon Lee, Daejeon (KR); Hyeok Chan Kwon, Daejeon (KR); Gae II An, Daejeon (KR); Byung Ho Chung, Daejeon (KR)

(73) Assignee: Electronics and Telecommunications Research Institute, Daejeon (KR)

(21) Appl. No.: 13/954,068

(22) Filed: Jul. 30, 2013

(30) Foreign Application Priority Data
Sep. 14, 2012 (KR) 10-2012-0102009

(51) Int. Cl. H04W 12/08

(52) U.S. Cl. CPC H04W 12/08
USPC 726/23

(57) ABSTRACT

Disclosed is a dongle device for wireless intrusion prevention, which can provide a wireless intrusion prevention service to a wireless access point in a wireless local area communication network. A dongle device for wireless intrusion prevention including an interface unit connected to an access point and configured to receive a data frame from the access point, a control unit configured to determine a security threat on the basis of the received data frame and generate prevention information if there is the security threat according to the determination result, and a storage unit configured to store information for security threat determination can make an existing wireless access point a wireless access point that can provide wireless intrusion prevention.

### CLAIM FOR PRIORITY

This application claims priority to Korean Patent Application No. 10-2012-0102009 filed on Sep. 14, 2012 in the Korean Intellectual Property Office (KIPO), the entire contents of which are hereby incorporated by reference.

### BACKGROUND

1. Technical Field

Example embodiments of the present invention relate in general to a wireless communication apparatus and more specifically to a dongle device for wireless intrusion prevention which can provide a function of wireless intrusion prevention to a wireless access point.

2. Related Art

A wireless local area communication network is getting a spotlight as mobile devices such as a notebook, a personal digital assistant (PDA), or a smartphone are being developed. In particular, a smartphone uses data service and voice over Internet protocol (VoIP) over a wireless local area communication network instead of a mobile communication system requiring a high cost.

The wireless local area communication network defined in several IEEE standards such as IEEE 802.11 protocol performs transmission using a public radio frequency and thus significantly requires wireless security. A wireless local area communication network connects a wireless device with an existing network using an access point (AP). Encryption of data in a wireless area which is between the wireless device and the access point is performed using IEEE 802.11i. In order to secure security in the wireless area which is between the wireless device and the access point, the access point sends a connection request of a user terminal to an authentication server at a back-end to perform an authentication process. And then the access point provides a security function of encrypting user data in the wireless area which is between the user terminal and the access point using an encryption key for the wireless area. The encryption key is received from the authentication server according to a wireless LAN security standard (IEEE 802.11i). Accordingly, most of access points according to the above standard may secure data security of the wireless section. However, the access points according to the above standard have vulnerability of wireless security cannot prevent a wireless intrusion such as a denial of service (DoS) or phishing attack to the access point.

A wireless intrusion prevention system (WIPS) is a system for overcoming the vulnerability of wireless security. The wireless intrusion prevention system detects intrusion from unauthorized access points or wireless devices using a wireless spectrum and automatically prevents the intrusion.

A main objective of the wireless intrusion prevention system is to prevent an unauthorized access to a region and asset of a wireless local area communication network. To this end, generally, the wireless intrusion prevention system is configured to be overlapped with an existing wireless local area communication network. A general wireless intrusion prevention system includes a wireless monitoring sensor, a wireless intrusion prevention appliance, a console, and optionally a database server.

The wireless monitoring sensor includes a radio frequency (RF) module and an antenna which can monitor packets of wireless spectrum of the wireless local area communication network for the purpose of security. The wireless monitoring sensor sequentially monitors respective channels in order to monitor all radio channels in the vicinity of the wireless monitoring sensor (for example, the number of Korean channels of IEEE 802.11b/g is 13), and collects wireless packets.

The wireless intrusion prevention appliance provides a function of analyzing the packets collected by each wireless monitoring sensor, determining a wireless intrusion and threat, and preventing the wireless intrusion and threat. The console provides a user interface to the wireless intrusion prevention system.

FIG. 1 illustrates a wireless intrusion prevention system used in a company.

Referring to FIG. 1, the wireless intrusion prevention system may include a first wireless monitoring sensor 10, a second wireless monitoring sensor 20, a wireless intrusion prevention appliance 30, etc. The first wireless monitoring sensor 10 has a monitoring range 70 where a first wireless access point 40 providing a service on channel number 1 and a second wireless access point 50 providing a service on channel number 5. A third wireless access point 60 providing a service on channel number 6 is out of the monitoring range 70 of the first wireless monitoring sensor 10. The third wireless access point 60 may be monitored using the second wireless monitoring sensor 20.

The wireless intrusion prevention system having such a configuration has a limitation in that an error probability in detection of a wireless intrusion and threat increases as the number of channels to be monitored by the wireless monitoring sensor increases over 50 and thus data traffic rapidly increases to several Gbps when the wireless intrusion prevention system reaches a wireless LAN transmission rate from hundreds of Mbps (for example, IEEE 802.11n) to several Gbps (for example, IEEE 802.11ac). Also, the wireless intrusion prevention system includes a monitoring sensor, a wireless intrusion prevention appliance, a console, etc. and thus has another limitation in that the wireless intrusion prevention system is difficult to be applied to a wireless local area communication network using a personal access point.

### SUMMARY

Accordingly, example embodiments of the present invention are provided to substantially obviate one or more problems due to limitations and disadvantages of the related art.

Example embodiments of the present invention provide a dongle device for wireless intrusion prevention, which can use an access point of a wireless local area communication network.

In some example embodiments, a dongle device for wireless intrusion prevention includes an interface module connected to an access point and configured to receive a data frame from the access point, a security threat detection module configured to determine a security threat on the basis of the received data frame and provide the determination result, and a security threat prevention module configured to generate prevention information if there is the security threat according to the determination result provided from the security threat detection module.

Here, the interface module may request the access point to provide setting information about the access point and receive the provided setting information, and the security threat detection module may detect a security threat on the basis of the setting information about the access point.

Here, the setting information about the access point may include at least one of service channel information, a service set identifier (SSID) setting value, a security setting, and an encryption key for IEEE 802.11i.

Here, the prevention information may indicate disassociation or deauthentication between the access point and/or at least one access point and devices, and the security threat prevention module may deliver the prevention information to the access point through the interface module.

Here, the security threat prevention module may directly perform disassociation or deauthentication between the access point and/or at least one access point and devices, using the prevention information.

In other example embodiments, a dongle device for wireless intrusion prevention includes an interface unit connected to an access point and configured to receive a data frame from the access point, a control unit configured to determine a security threat on the basis of the received data frame and generate prevention information if there is the security threat according to the determination result, and a storage unit configured to store information for security threat determination.

Here, the control unit may generate a disassociation message or deauthentication message for disassociation or deauthentication between the access point and/or at least one access point and devices, using the prevention information.

Here, the dongle device for wireless intrusion prevention may further include a communication unit configured to collect a data frame and transmit the disassociation message or deauthentication message for disassociation or deauthentication between the access point and/or at least one access point and devices, in correspondence with the prevention information of the control unit.

Here, the control unit may provide, to the access point through the interface unit, the prevention information used to generate a disassociation message or deauthentication message for disassociation or deauthentication between the access point and/or at least one access point and devices.

### BRIEF DESCRIPTION OF DRAWINGS

Example embodiments of the present invention will become more apparent by describing in detail example embodiments of the present invention with reference to the accompanying drawings, in which:

FIG. 1 illustrates a wireless intrusion prevention system used in a company;

FIG. 2 illustrates a wireless intrusion prevention service based on a wireless access point using a dongle device for wireless intrusion prevention according to an embodiment of the present invention;

FIG. 3 is an exemplary diagram of a hardware configuration of a dongle device for wireless intrusion prevention according to an embodiment of the present invention;

FIG. 4 is an exemplary diagram of a functional block for wireless intrusion prevention of a dongle device for wireless intrusion prevention according to an embodiment of the present invention; and

FIG. 5 is an exemplary flowchart of a functional block for wireless intrusion prevention according to an embodiment of the present invention.

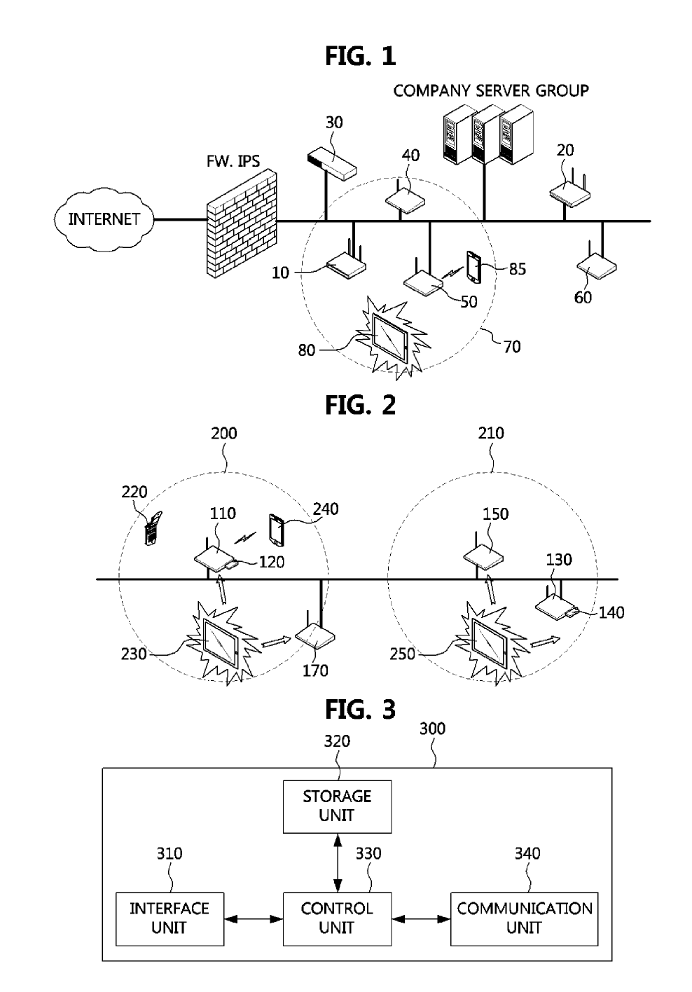

### DESCRIPTION OF EXAMPLE EMBODIMENTS

Since the present invention may have diverse modified embodiments, preferred embodiments are illustrated in the drawings and are described in the detailed description of the invention.

However, it should be understood that the particular embodiments are not intended to limit the present disclosure to specific forms but rather the present disclosure is meant to cover all modification, similarities, and alternatives which are included in the spirit and scope of the present disclosure.

In the following description, the technical terms are used only for explaining a specific exemplary embodiment while not limiting the present disclosure. The terms of a singular form may include plural forms unless referred to the contrary. The meaning of “comprise,” “include,” or “have” specifies the presence of stated features, integers, steps, operations, elements, components, and/or groups thereof, but does not preclude the presence or addition of one or more other features, integers, steps, operations, elements, components, and/or groups thereof.

Unless terms used in the present disclosure are defined differently, the terms may be construed as meaning known to those skilled in the art. Terms such as terms that are generally used and have been in dictionaries should be construed as having meanings matching with contextual meanings in the art. In this description, unless defined clearly, terms are not ideally or excessively construed as formal meanings.

In the present invention, a dongle device for wireless intrusion prevention is connected to an existing wireless access point through an expansion device, and thus the existing wireless access point having the dongle device connected thereto can be operated as an access point having a function of wireless intrusion prevention. The present invention will be described with reference to embodiments thereof.

FIG. 2 illustrates a wireless intrusion prevention service based on a wireless access to point using a dongle device for wireless intrusion prevention according to an embodiment of the present invention.

A first wireless access point 110 is a wireless access point connected to a dongle device for wireless intrusion prevention 120 and configured to provide a function of wireless intrusion prevention, and communicates data with wireless devices, for example using service channel number 1 in a first wireless access point service area 200.

A second wireless access point 130 is a wireless access point connected to a dongle device for wireless intrusion prevention 140 and configured to provide a function of wireless intrusion prevention, and communicates data with wireless devices, for example, using service channel number 5 in a second wireless access point service area 210.

A third wireless access point 150 is a general wireless access point and communicates data with wireless devices, for example, using service channel number 13.

A fourth wireless access point 170 is a general wireless access point and communicates data with wireless devices, for example, using the service channel number 1.

For example, if authorized first and second wireless terminal devices 220 and 240 use a data service through the service channel number 1 of the first wireless access point 110, and an unauthorized terminal 230 attempts a wireless intrusion to the first wireless access point 110 through the service channel number 1 in the first wireless access point service area 200, then the dongle device for wireless intrusion prevention 120 connected to the first wireless access point 110 detects and prevents a security threat from the unauthorized terminal 230. The first wireless access point 110 collects data frames of the channel number 1 through which a service is currently provided

Also, if an unauthorized terminal 250 attempts wireless intrusion to the second wireless access point 130 through the service channel number 5 in the second wireless access point service area 210, then the dongle device for wireless intrusion prevention 140 connected to the second wireless access point 130 detects and prevents a security threat from the unauthorized terminal 250. The second wireless access point 130 collects data frames of the channel number 5 through which a service is currently provided.

If the unauthorized terminal 250 attempts wireless intrusion to the third wireless access point 150 through the service channel number 13 in the second wireless access point service area 210, then the dongle device for wireless intrusion prevention 140 connected to the second wireless access point 130 cannot detect a security threat to the third wireless access point 150. The second wireless access point 130 collects data frames of the channel number 5 through which a service is currently provided.

Also, if the unauthorized terminal 230 attempts wireless intrusion to the fourth wireless access point 170 through the service channel number 1 in the first wireless access point service area 200, then the dongle device for wireless intrusion prevention 120 connected to the first wireless access point 110 detects and prevents a security threat from the unauthorized terminal 230. The first wireless access point 110 collects data frames of the channel number 1 through which a service is currently provided.

As described above, the dongle device for wireless intrusion prevention is connected to an access point having an expansion device. Thus the access point having the dongle device connected thereto detects a wireless threat to a currently serviced channel using an embedded function of wireless intrusion prevention and prevents the wireless threat to the wireless access point and other access points using the same service channel in the same service area.

Since the dongle device for wireless intrusion prevention is used in connection with an existing wireless access point having an expansion device, the dongle device for wireless intrusion prevention advantageously do not omit or delay detection and prevention of a wireless intrusion attack to the wireless access point and other access points using the same service channel, unlike an existing wireless monitoring sensor that to sequentially monitors all channels in order to monitor a wireless threat to all wireless access points existing in a monitoring area.

Also, since the dongle device for wireless intrusion prevention is used in connection with an existing wireless access point having an expansion device, the wireless intrusion detection area is the same as the service area of the wireless access point, thereby preventing detection omission of a wireless intrusion attack, which is caused because the monitoring area is different from the service area when a separate wireless monitoring sensor is used.

Unlike a company using several or many wireless access points, an individual uses only one wireless access point and has concerns about a wireless intrusion to the only one access point. Thus, the dongle device for wireless intrusion prevention may advantageously prevent the wireless intrusion to a currently serviced channel without an additional appliance although the dongle device cannot prevent any wireless attack to wireless channels other than the channel on which the wireless access point is providing a service.

FIG. 3 is an exemplary diagram of a hardware configuration of a dongle device for wireless intrusion prevention according to an embodiment of the present invention.

A dongle device for wireless intrusion prevention 300 includes an interface unit 310 connected to an expansion port of a wireless access point, a storage unit 320 storing a function of wireless intrusion prevention and information for security threat determination, and a control unit 330 executing the function of wireless intrusion prevention. And, the dongle device may further include a communication unit 340 monitoring a signal from a wireless device and transmitting a signal to the wireless device.

The interface unit 310 is an interface for connecting the dongle device for wireless intrusion prevention 300 to an existing wireless access point and may include a universal serial bus (USB), peripheral component interconnect bus (PCI), mini-PCI, etc.

The dongle device for wireless intrusion prevention 300 collects setting information about a wireless access point connected through the interface unit 310 and data frames of a channel on which the wireless access point is providing a service. The control unit 330 of the dongle device for wireless intrusion prevention 300 transmits prevention information about a wireless intrusion to the wireless access point through the interface unit 310. The message is, for example, a control message such as disassociation message or deauthentication message.

The storage unit 320 serves to store a function of wireless intrusion prevention and information needed to perform the function of wireless intrusion prevention.

The control unit 330 detects and prevents a wireless intrusion using a data frame and information of the wireless access point according to the function of wireless intrusion prevention stored in the storage unit 320.

The data frame is at least one of a data frame collected by the connected wireless access point from among data frames of a currently serviced channel and then delivered through the interface unit 310 and a data frame collected by the communication unit 340.

The control unit 330 delivers prevention information about a wireless intrusion to a wireless access point or the communication unit 340 connected through the interface unit 310, and thus prevents a wireless security threat.

The communication unit 340 may be optionally included in the dongle device for wireless intrusion prevention 300. For example, the communication unit 340 may include a Wi-Fi antenna and a Wi-Fi modem. Thus, without using a communication resource of a connected wireless access point, the communication unit 340 collects a data frame of a currently serviced channel to monitor the wireless security threat. Also, the communication unit 340 generates a wireless intrusion prevention message without the connected wireless access point according to selection of the control unit 330 and then transmits a disassociation message or a deauthentication message for disassociation or deauthentication between the access point and/or at least one other access point and devices. Accordingly, the reduction in RF processing performance and data frame processing performance of the connected wireless access point can be prevented, and the performance in wireless intrusion detection and wireless intrusion prevention can be enhanced.

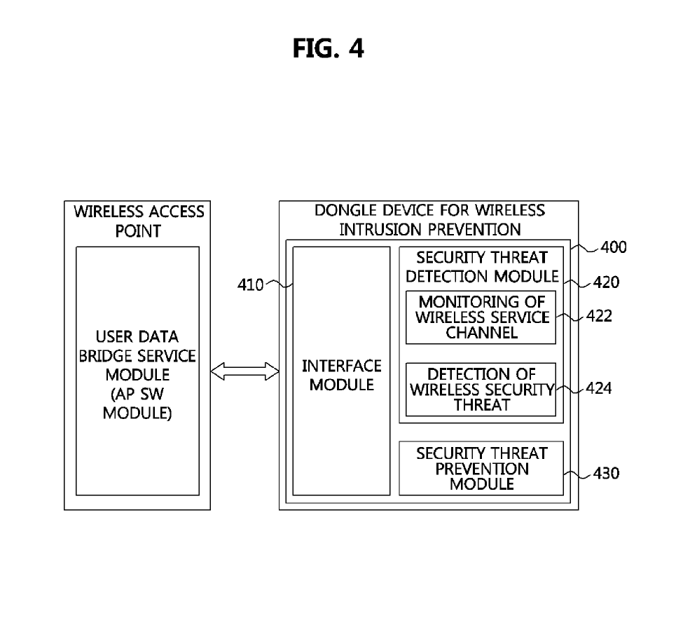

FIG. 4 is an exemplary diagram of a functional block for wireless intrusion prevention of a dongle device for wireless intrusion prevention according to an embodiment of the present invention.

A functional block for wireless intrusion prevention 400 include an interface module 410 between a wireless access point and the dongle device for wireless intrusion prevention, a security threat detection module 420, and a security threat prevention module 430.

The interface module 410 is an access point information export module and acquires setting information about the access point, for example, service channel information, a service set identifier (SSID) setting value, a security setting, and an encryption key for IEEE 802.11i, from a user data service module (AP software module) of the connected wireless access point.

Also, the interface module 410 serves to deliver a data frame of a currently serviced channel collected by the connected wireless access point and deliver prevention information about a wireless security threat from the security threat prevention module 430 to the connected wireless access point.

The functional block for wireless intrusion prevention 400 sets a service channel monitored by the dongle device for wireless intrusion prevention, a data analysis level (for example, an analysis level including packet data using an encryption key of the connected wireless access point other than packet header information), etc., on the basis of the setting information of the connected wireless access point acquired through the interface module 410.

A wireless service channel monitoring unit 422 of the security threat detection module 420 monitors all data frames (for example, a user data frame, a wireless LAN management frame, a wireless LAN control frame, etc.) transmitted and received over a currently serviced channel, according to the currently set service channel and wireless data analysis level.

The dongle device for wireless intrusion prevention of the present invention does not monitor all channels (13 or more channels) with a scheduler, but monitors a wireless intrusion using all data frames collected by the connected wireless access point from the currently serviced channel, thereby preventing the wireless intrusion to the connected wireless access point without interruption of monitoring.

Also, the data frame collected by the communication unit that may be included in the dongle device for wireless intrusion prevention of the present invention is also a data frame collected from the currently serviced channel by the connected wireless access point.

Accordingly, the dongle device for wireless intrusion prevention can prevent a wireless intrusion to the channel on which the currently connected wireless access point is providing a service, without interruption of monitoring that is caused by an existing wireless monitoring sensor monitoring all channels (13 or more channels) with a scheduler, thereby enhancing accuracy in intrusion detection and intrusion prevention.

A wireless security threat detection unit 424 of the security threat detection module 420 determines a wireless threat of the channel currently being provided a service by the connected wireless access point on the basis of a data frame collected through the communication unit in the dongle device or the connected wireless access point.

The security threat prevention module 430 delivers to the connected access point or the communication unit prevention information for disassociation or deauthentication between the connected wireless access point and another wireless access point and devices according to the determination result of the security threat detection module 420.

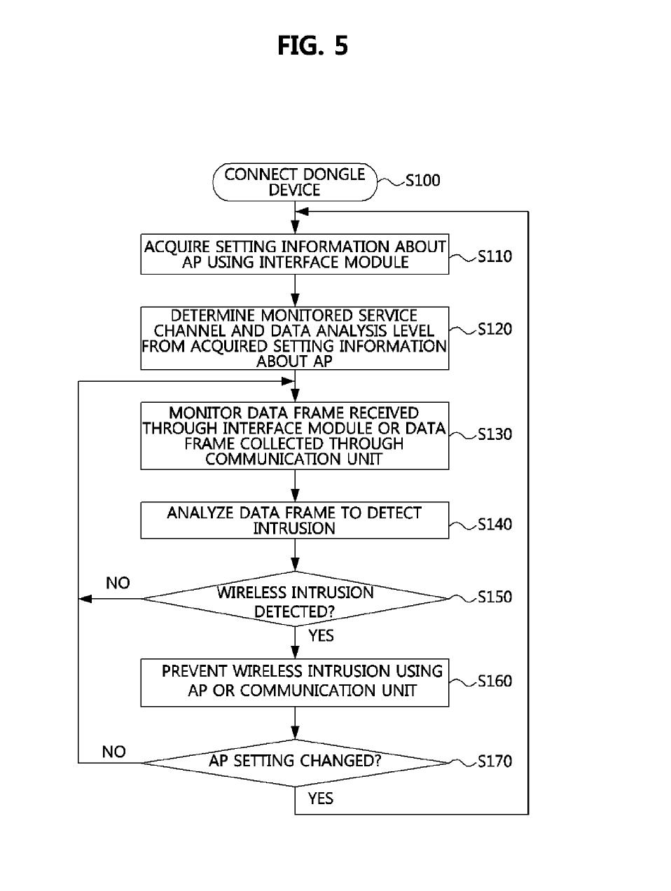

FIG. 5 is a flowchart illustrating an operation of a function of wireless intrusion prevention according to an embodiment of the present invention.

The function of wireless intrusion prevention of the dongle device for wireless intrusion prevention starts with connection to the dongle device S100.

The dongle device for wireless intrusion prevention acquires setting information about the wireless access point using an interface module S110.

For example, the acquired information may include service channel information, SSID information, a security setting, encryption key information, etc.

The dongle device for wireless intrusion prevention determines a monitored service channel and data analysis level on the basis of the acquired information about the wireless access point S120.

The dongle device for wireless intrusion prevention monitors a data frame collected through the interface module or a data frame collected through a communication unit S130.

The dongle device for wireless intrusion prevention analyzes the data frame and then, detects a wireless intrusion S140.

The dongle device for wireless intrusion prevention analyzes the data frame and then, determines the wireless intrusion S150.

As the determination result of S150, the dongle device for wireless intrusion prevention proceeds to S160 if there is a wireless intrusion, and returns to S130 if there is no wireless intrusion.

The dongle device for wireless intrusion prevention delivers prevention information to the wireless access point through the interface module or delivers prevention information to the communication unit in the dongle device in correspondence with the wireless intrusion S160.

The dongle device for wireless intrusion prevention returns to S110 if the setting of the connected wireless access point is changed S170.

For the sake of convenience, S170 is indicated next to S160. However, S170 may be performed at any step after S120.

As described above, the dongle device for wireless intrusion prevention that can provide a function of wireless intrusion prevention to the access point can prevent a wireless intrusion effectively in both a network having a wireless transmission rate of several Gbps such as IEEE 802.11ac, and a personal access point.

While the example embodiments of the present invention and their advantages have been described in detail, it should be understood that various changes, substitutions, and alterations may be made herein without departing from the scope of the invention.

What is claimed is:

1. A dongle device for wireless intrusion prevention comprising:
an interface module connected to an access point and configured to receive a data frame from the access point;
a security threat detection module configured to determine a security threat on the basis of the received data frame and provide the determination result; and
a security threat prevention module configured to generate prevention information if there is the security threat according to the determination result provided from the security threat detection module.

2. The dongle device of claim 1, wherein the interface module requests the access point to provide setting information about the access point and receives the provided setting information, and wherein the security threat detection module detects a security threat on the basis of the setting information about the access point.

3. The dongle device of claim 2, wherein the setting information about the access point comprises at least one of service channel information, a service set identifier (SSID) setting value, a security setting, and an encryption key for IEEE 802.11i.

4. The dongle device of claim 1, wherein the prevention information indicates disassociation or deauthentication between the access point and/or at least one access point and devices, and wherein the security threat prevention module delivers the prevention information to the access point through the interface module.

5. The dongle device of claim 1, wherein the security threat prevention module directly performs disassociation or deauthentication between the access point and/or at least one access point and devices, using the prevention information.

6. A dongle device for wireless intrusion prevention comprising:
an interface unit connected to an access point and configured to receive a data frame from the access point;
a control unit configured to determine a security threat on the basis of the received data frame and generate prevention information if there is the security threat according to the determination result; and
a storage unit configured to store information for security threat determination.

7. The dongle device of claim 6, wherein the control unit generates a disassociation message or deauthentication message for disassociation or deauthentication between the access point and/or at least one access point and devices, using the prevention information.

8. The dongle device of claim 7, further comprising a communication unit configured to collect a data frame and transmit the disassociation message or deauthentication message for disassociation or deauthentication between the access point and/or at least one access point and devices, in correspondence with the prevention information of the control unit.

9. The dongle device of claim 7, wherein the control unit provides, to the access point through the interface unit, the prevention information indicating generation of a disassociation message or deauthentication message for disassociation or deauthentication between the access point and/or at least one access point and devices.
